(19) United States
(12) Patent Application Publication
(10) Pub. No.: US 2008/0115676 A1
(43) Pub. Date: May 22, 2008

(54) Retractable structure of a grill

(76) Inventor: Samson Tsen, Taipei City (TW)

Correspondence Address: BIRCH STEWART KOLASCH & BIRCH, PO BOX 747, FALLS CHURCH, VA, 22040-0747, US

(21) Appl. No.: 11/602,359

(22) Filed: Nov. 21, 2006

(51) Int. Cl. A47J 37/06; A47J 37/00

(52) U.S. Cl. 99/391; 99/375; 99/377

(57) ABSTRACT

A retractable structure of a grill includes a lower grill base with a connecting groove at a rear end of the lower grill base and a limit portion on the connecting groove, and an upper grill cover and the lower grill base define a space for containing a foodstuff. The upper grill cover has a combining portion connected to the connecting groove, and the combining portion has a limit member to define a limit relation, such that the upper grill cover is connected horizontally with the lower grill base for providing a displacement travel and a rotation travel of the foodstuff. The upper grill cover can be turned over from the lower grill base and moved horizontally to fit the thickness of different foodstuffs. The distance between the upper grill cover and the lower grill base can be adjusted to evenly heat the whole surface of the foodstuff.

### FIELD OF THE INVENTION

The present invention relates to a retractable structure of a grill, and more particularly to a retractable structure with an upper grill cover capable of having displacement and rotation travels with respect to a lower grill base.

### BACKGROUND OF THE INVENTION

With the development of science and technology and the advancement of our society, people have increasingly higher demands on basic necessities of life including food, clothing, housing and transportation. For instance, consumers simply need to have appropriate materials and simple knowledge for the operations of a common electric grill to bake muffins or fry sliced meat, or other foodstuffs. Home made muffins and foods are not only sanitary and delicious, but also are money-saving, time-saving and convenient, and thus they are welcome by consumers and become a prevailing custom.

Referring to R.O.C. Pat. Publication No. 497695 entitled “Upper grill cover opening structure of an electric grill” and U.S. Pat. No. 6,016,741 for the disclosure of traditional electric grills, a grill mainly includes an upper grill cover and a lower grill base pivotally coupled with each other by a hinge, and the upper grill cover and the lower grill base have an upper casing and a lower casing disposed at the top and bottom of the grill respectively, so that the upper grill cover can be turned over by the hinge and stacked onto the lower grill base to close the grill, or the latched upper and lower casings can be lifted perpendicularly with the lateral side of the lower grill base. The grill can be used for baking or frying food when the upper grill cover is stacked on and engaged with the lower grill base.

Although the foregoing hinge can achieve the purpose of lifting open the upper grill cover, the following shortcomings still exist in the practical application of a grill. To achieve an evener grilling effect, the upper grill cover and the lower grill base of an electric grill generally have heat conductors that can be turned over together with the upper grill cover. The foodstuff such as sliced meat can be clamped to achieve a double-sided grilling effect. However, if a foodstuff with a larger thickness is grilled, the too-thick foodstuff will be restricted (as shown in FIG. 1), since the traditional upper grill cover is pivotally connected to the lower grill base by the hinge and the upper grill cover is stacked onto the lower grill base, and the top of the foodstuff cannot be heated evenly, and the grill mark so produced will not be obvious. Although some traditional structures enlarge the pivotal hole to allow a displacement of the hinge after the upper grill cover is closed, a specific height can be adjusted or the upper grill cover can be lifted to its highest point and turned over. However, the adjustable distance is very limited and the operation is not convenient at all, and such traditional structures still cannot solve the foregoing problems.

Therefore, it is a primary objective of the present invention to provide a retractable structure of a grill wherein its upper grill cover can be turned open with respect to the lower grill base and maintained horizontally and displaced with respect to the lower grill base to fit the thickness of different foodstuffs and carry out a stepless adjustment.

A secondary objective of the present invention is to maintain the foodstuff in a horizontal contact with the upper grill cover while the foodstuff is being cooked to form a grill mark on the surface of the foodstuff and provide even heating.

A third objective of the present invention is to provide a more convenient operation simply by lifting and turning over the upper grill cover.

A fourth objective of the present invention is to drain excessive grease into a drip pan under the grill and along an inclined grill to facilitate users to clean up the grill after its use.

To achieve the foregoing objectives, a preferred embodiment of the present invention comprises: a lower grill base with a connecting groove disposed at a rear end of the lower grill base and a limit portion disposed on a sidewall of the connecting groove, and an upper grill cover and the lower grill base define a space for containing a foodstuff. The upper grill cover has a combining portion connected to the connecting groove, and a lower edge of the combining portion has a limit member for passing the combing portion, such that the upper grill cover can be in a horizontal contact with the foodstuff to provide a displacement travel of the foodstuff with respect to the lower grill base and define an opening angle and a closing angle by the limit member to have a rotation travel with respect to said lower grill base.

### BRIEF DESCRIPTION OF THE DRAWINGS

FIG. 1 is a schematic view of an application of a traditional structure;

FIG. 2 is a perspective view of a structure in accordance with a preferred embodiment of the present invention;

FIG. 3 is an exploded view of a structure in accordance with a preferred embodiment of the present invention;

FIGS. 4A and 4B are schematic views of successive movements in accordance with a preferred embodiment of the present invention;

FIG. 5 is a cross-sectional side view of a preferred embodiment of the present invention; and

FIGS. 6A˜6C are schematic views of successive movements in accordance with another preferred embodiment of the present invention.

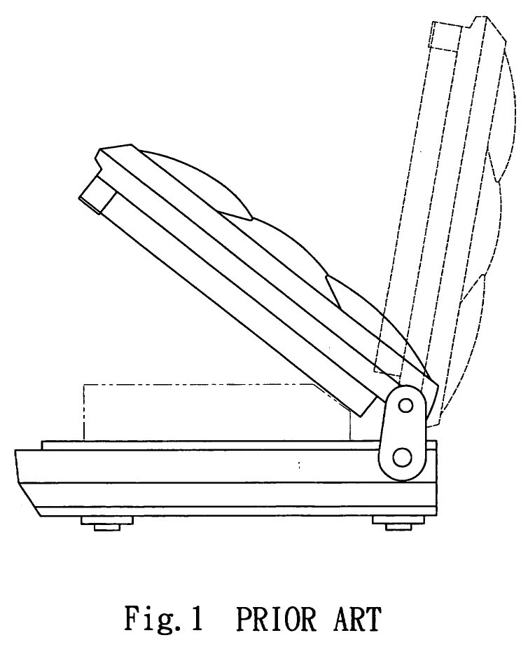

### DETAILED DESCRIPTION OF THE PREFERRED EMBODIMENTS

The present invention will now be described in more detail hereinafter with reference to the accompanying drawings as follows:

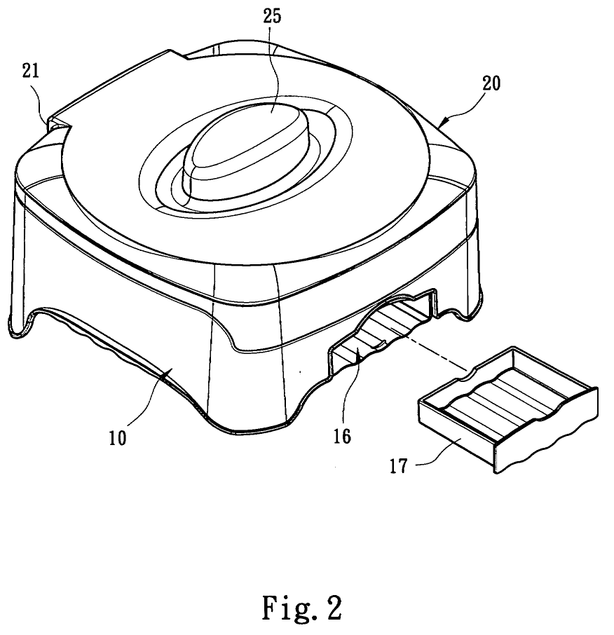

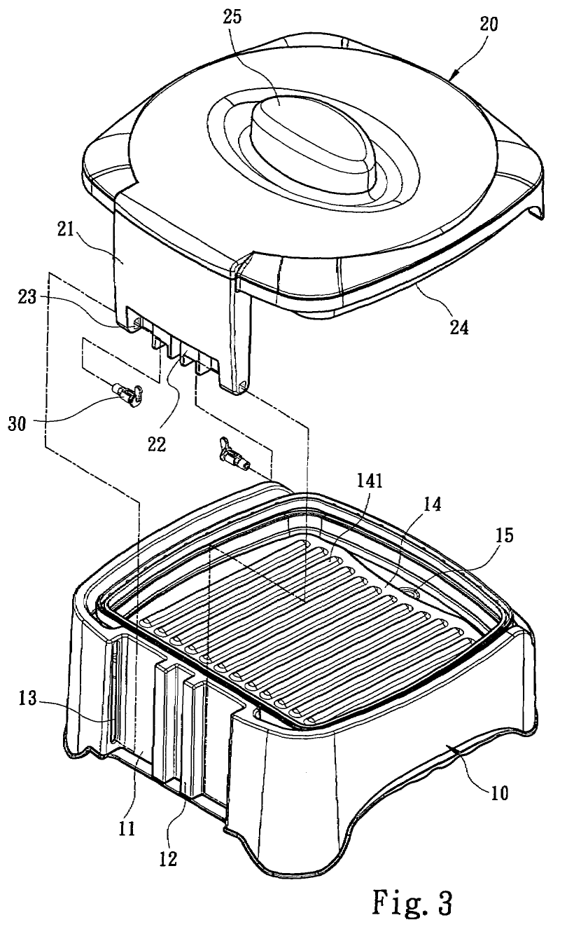

Referring to FIGS. 2 and 3 for a structure of a preferred embodiment of the present invention, the present invention relates to a retractable structure of a grill that comprises: a lower grill base 10, a connecting groove 11 disposed at a rear end of the lower grill base 10, and a limit portion 13 disposed on a sidewall of the connecting groove 11. The lower grill base 10 is connected to an upper grill cover 20, and the upper grill cover 20 has a force applying portion 25 provided for users to lift and turn over the whole upper grill cover 20 and a combining portion 21 coupled to the connecting groove 11. The connecting groove 11 and the combining portion 21 have a guide post 12 and a sheathing portion 22 sheathed into the guide post 12, wherein the guide post 12 and the sheathing portion 22 can be installed in opposite directions. A lower edge of the combining portion 21 has a through hole 23, and the through hole 23 has a limit member 30 that is passed through the limit portion 13 (the limit portion 13 and the limit member 30 can be transposed to assemble op oppositely).

The upper grill cover 20 and the lower grill base 10 have corresponding upper and lower heat conductors 24, 14, and the interior of the upper and lower heat conductors 24, 14 includes an electric heating pipe (not shown in the figure) with a heating function, wherein the upper and lower heat conductors 24, 14 install a plurality of rows of protruding strips 141 for forming a grill mark on the surface of the cooked foodstuff that can make the foodstuff look better, and the lower heat conductor 14 has an inclination, and the lower grill base 10 has an oil drain outlet 15 and a containing space 16 interconnected with the oil drain outlet 15, and the containing space 16 includes a detachable drip pan 17, so that excessive grease will flow along the inclination into the drip pan 17. While enjoying good food, we also can take care of our health. Further, the drip pan 17 adopts a detachable design to facilitate users to clean up the grill afterwards.

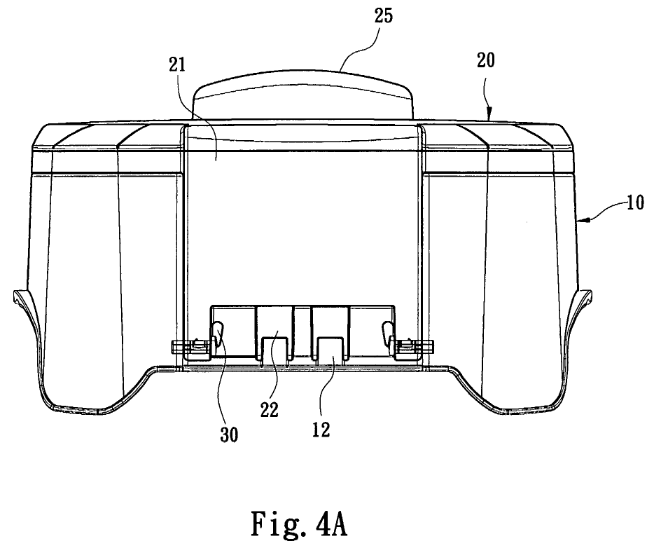

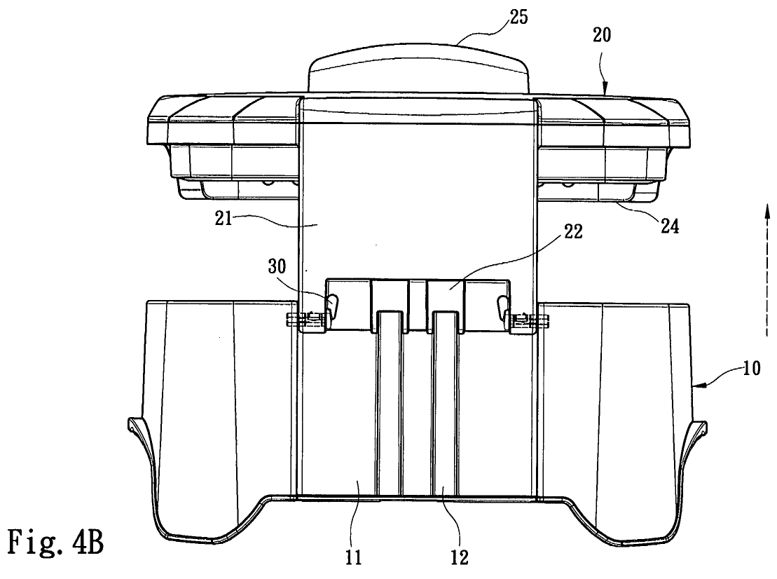

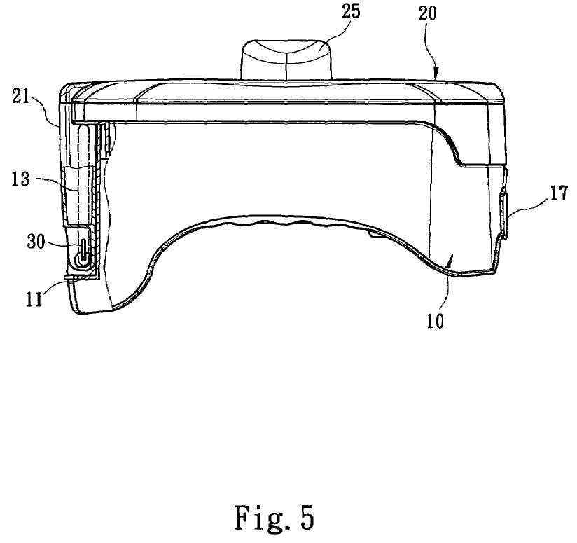

Referring to FIGS. 4A and 4B for successive movements in accordance with a preferred embodiment of the present invention, a user can lift the whole upper grill cover 20 by the force applying portion 25. Since the connecting groove 11 of the lower grill base 10 has a guide post 12, and the combining portion 21 of the upper grill cover 20 has a corresponding sheathing portion 22 to be sheathed into the guide post 12. The limit member 30 can be displaced together with the upper grill cover 20 in the limit portion 13, such that the upper grill cover 20 has a displacement travel along the guide post 12 and starting from the sheathing portion 22 (as shown in FIG. 5).

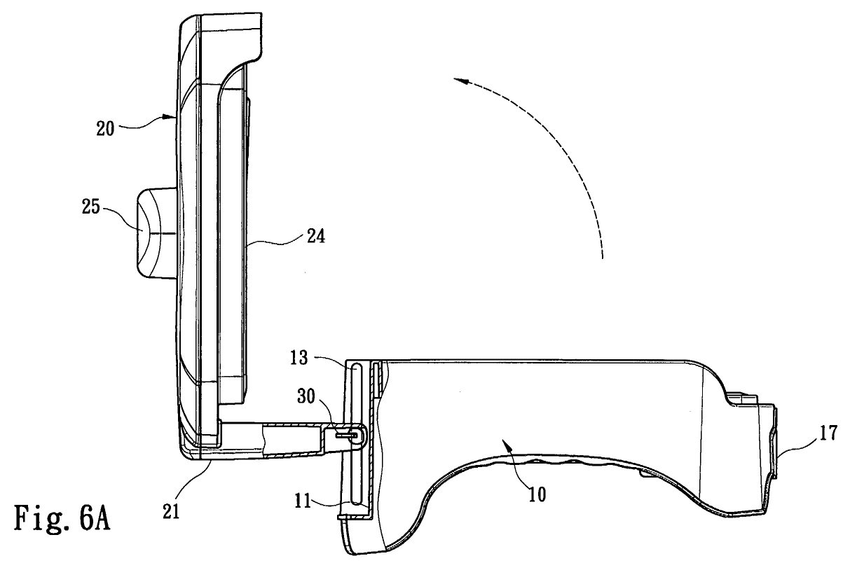

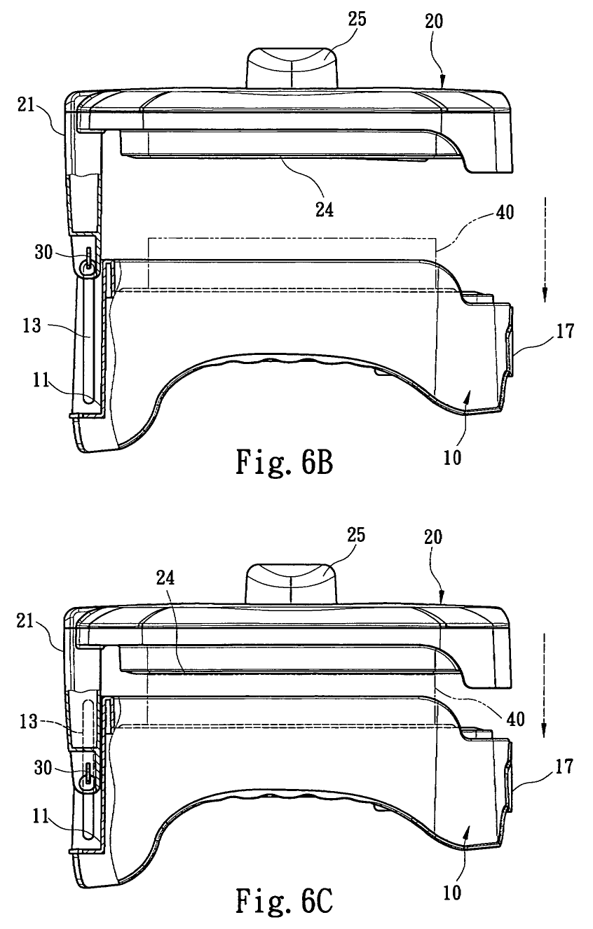

Referring to FIGS. 6A˜6C for successive movements in accordance with another preferred embodiment of the present invention, the upper grill cover 20 defines an upward moving height of the combining portion 21 which is greater than the thickness of the combining portion 21, and defines such position as a starting point of a rotation travel. If the combining portion 21 of the upper grill cover 20 is situated at the lowest end of the connecting groove 11, the combining portion 21 will be stopped by the thickness of the combining portion 21 to restrict its rotation travel. The restriction can be released when the combining portion 21 is lifted slight and displaced to a distance greater than the thickness. Therefore, the upper grill cover 20 in accordance with the invention can be lifted slightly and turned to an opening angle to make the operations more convenient (as shown in FIG. 6A). After the upper grill cover 20 is opened, a foodstuff 40 can be put in, and the upper grill cover 20 can be returned to its horizontal position to constitute a closing angle (as shown in FIG. 6B) and displaced steadily towards the lower grill base 10 to fit different thicknesses of various different foodstuffs and carry out a stepless adjustment. The foodstuff 40 can be in a horizontal contact with the upper grill cover 20 when it is cooked (as shown in FIG. 6C), so as to achieve the effects of forming a grill mark on the surface of the foodstuff 40 and providing even heating.

While the invention has been described by means of specific embodiments, numerous modifications and variations could be made thereto by those skilled in the art without departing from the scope and spirit of the invention set forth in the claims.

What is claimed is:

1. A retractable structure of a grill, comprising:
a lower grill base, having a connecting groove disposed at a rear end of said lower grill base;
an upper grill cover, together with said lower grill base for defining an included space for containing a foodstuff, and said upper grill cover having a combining portion coupled to a connecting groove, and a sidewall of said connecting groove and a lower edge of said combining portion correspondingly provided for said upper grill cover to be in a horizontal contact with said foodstuff that can have a displacement travel with respect to said lower grill base, and define an opening angle and a closing angle by said limit member to have a rotation travel with respect to said lower grill base.

2. The retractable structure of a grill of claim 1, wherein said connecting groove and said combining portion separately have a corresponding guide post and a sheathing portion sheathed into said guide post.

3. The retractable structure of a grill of claim 1, wherein said combining portion has a through hole for passing said limit member.

4. The retractable structure of a grill of claim 1, wherein said upper grill cover defines the position of said upward moving combining portion with a height greater than the thickness of said combining portion as a starting point of said rotation travel.

5. The retractable structure of a grill of claim 1, wherein said upper grill cover has a force applying portion for driving said upper grill cover.

6. The retractable structure of a grill of claim 1, wherein said upper grill cover and said lower grill base have corresponding upper and lower heat conductors respectively.

7. The retractable structure of a grill of claim 6, wherein said upper and lower heat conductors have a plurality of strips for producing a grill mark.

8. The retractable structure of a grill of claim 6, wherein said lower heat conductor is inclined with an inclination.

9. The retractable structure of a grill of claim 8, wherein said lower grill base includes an oil drain outlet, a containing space interconnected with said oil drain outlet, and a detachable drip pan disposed in said containing space.

10. The retractable structure of a grill of claim 1, wherein said limit portion and said limit member can be transposed to assemble oppositely.
